(19) United States
(12) Patent Application Publication
(10) Pub. No.: US 2026/0253998 A1
(43) Pub. Date: Aug. 27, 2026

(54) MULTILAYERED, ENCAPSULATED BATTERY PACK THERMAL INSULATOR

(71) Applicant: SYSTEMS PROTECTION GROUP US LLC, Northville, MI (US)

(72) Inventors: STEVEN M. GALAMBA, NORTHVILLE, MI (US); ERICH ECKHARD WEISSFLOG, NORTHVILLE, MI (US); ALEXA BRADY, NORTHVILLE, MI (US)

(21) Appl. No.: 19/545,672

(22) Filed: Feb. 20, 2026

Related U.S. Application Data
(60) Provisional application No. 63/761,584, filed on Feb. 21, 2025.

(51) Int. Cl. H01M 10/658; H01M 50/249; H01M 50/291; H01M 50/293

(52) U.S. Cl. CPC H01M 10/658; H01M 50/249; H01M 50/291; H01M 50/293

(57) ABSTRACT

A thermal insulator for a battery pack a nonwoven layer includes a thermal barrier layer abutting the nonwoven layer and a polymeric outer layer, wherein the nonwoven layer and the thermal barrier layer are encapsulated by the polymeric outer layer.

### CROSS-REFERENCE TO RELATED APPLICATION

This application claims the benefit of U.S. Provisional Application Serial No. 63/761,584, filed February 21, 2025, which is incorporated herein by reference in its entirety.

### BACKGROUND OF THE INVENTION

### Technical Field

This invention relates generally to thermal insulators, and more particularly to thermal insulators for inhibiting flame propagation between and from cells of a battery pack of an electric vehicle.

### Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation by itself does not provide a desired level of protection against extreme heat and/or flame propagation, such as may be experienced in a thermal runaway condition of one or more cells of the electric vehicle battery pack. Further, disposing the fiberglass fabric between cells or cell modules is complicated due to the relatively high surface friction of the fabric. As shown in FIGS. 2A-2C, a battery pack 12 and housing 14 thereof are shown having a fiberglass insulator between and about cells, also referred to as cell modules 16, of the battery pack 12. The fiberglass insulator can result in a thermal runaway condition originating in any one of the cell modules 16 of the battery pack 12, such that heat and flame propagates from a single cell module 16 (FIG. 2A) to multiple cell modules (FIG. 2C), in less than 5 minutes at a temperature of 1000 ^{o}C.

It is desired to provide a thermal insulation that inhibits the propagation of flame between cells of a battery pack for 5 minutes or more at a temperature of 1000 ^{o}C – 1200 ^{o}C.

### SUMMARY OF THE INVENTION

It is an object of the present disclosure to provide a thermal insulator for use with an electric vehicle battery pack that addresses at least the desire to inhibit the propagation of flame from the battery pack for 5 minutes or more at a temperature of 1000 – 1200 ^{o}C.

It is a further object of the present disclosure to provide a thermal insulator for use with an electric vehicle battery pack that minimizes the amount of flame fuel present within the multilayer material, thereby inhibiting the propagation of flame between cells of the battery pack.

It is a further object of the present disclosure to provide a thermal insulator for use with an electric vehicle battery pack that is flexible, lightweight, has a thin, low profile to minimize the amount of space occupied by the thermal insulator, is economical in manufacture and easy to assemble between cells of a cell module.

One aspect of the invention provides a thermal insulator for a battery module including a nonwoven layer, a thermal barrier layer abutting the nonwoven layer, and a polymeric outer layer, wherein the nonwoven layer and the thermal barrier layer abutting the nonwoven layer are encapsulated by the polymeric outer layer.

In accordance with another aspect of the invention, the polymeric outer layer is heat-shrunk into a close fit with the nonwoven layer and the thermal barrier layer.

In accordance with another aspect of the invention, the thermal barrier layer includes a textile fabric layer interlaced with yarns resistant to high temperature.

In accordance with another aspect of the invention, the yarns of the textile fabric layer are woven.

In accordance with another aspect of the invention, the yarns of the textile fabric layer include multifilaments of mineral yarn.

In accordance with another aspect of the invention, the yarns of the textile fabric layer include multifilaments of fiberglass.

In accordance with another aspect of the invention, the thermal barrier layer includes a mica-based coating.

In accordance with another aspect of the invention, the thermal barrier layer includes a polymeric film, wherein the mica-based coating is sandwiched between the textile fabric layer and the polymeric film.

In accordance with another aspect of the invention, the polymeric film is one of a PEEK material and a polyester material.

In accordance with another aspect of the invention, the nonwoven layer has a gsm between about 2500-9000gsm.

In accordance with another aspect of the invention, the nonwoven layer is a mineral material.

In accordance with another aspect of the invention, the outer heat-shrunk polymeric layer has a gauge between about 50-90.

In accordance with another aspect of the invention, the nonwoven wall has a thickness between about 24-30mm.

In accordance with another aspect of the invention, a thermal insulator for a battery module consists of: a nonwoven layer, a thermal barrier layer abutting the nonwoven layer, and an outer heat-shrunk polymeric layer, wherein the nonwoven layer and the thermal barrier layer are encapsulated by the outer heat-shrunk polymeric layer.

In accordance with another aspect of the invention, an electric vehicle battery pack includes a housing with a plurality of cell modules bounded by the housing. The cell modules are spaced from one another by a gap, and a thermal insulator, including a nonwoven layer, a thermal barrier layer abutting the nonwoven layer and an outer heat-shrunk polymeric layer encapsulating the nonwoven layer and the thermal barrier layer, is compressed within the gap.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a thermal insulator constructed in accordance with an aspect of the invention;

FIGS. 2A-2C illustrate a schematic representation of an electric vehicle battery pack in accordance with prior art, not having a thermal insulator in accordance with the disclosure, undergoing a thermal runaway condition with a flame propagating from a location of flame initiation (FIG. 2A) throughout a plurality of cells of the battery pack (FIG. 2C);

FIGS. 3A-3C are views similar to FIGS. 2A-2C, with the electric vehicle battery pack including the thermal insulator constructed in accordance with an aspect of the disclosure, with the thermal insulator shown suppressing and inhibiting flame propagating from a location of a thermal runaway condition within a cell (FIG. 3A) throughout the plurality of cells of the battery pack (FIG. 3C);

FIG. 4 illustrates a plurality of the thermal insulators in accordance with a non-limiting embodiment of the disclosure;

FIG. 5A is a cross-sectional view taken generally along the line 5A-5A of one of the thermal insulators of FIG. 4; and

FIG. 5B is a view similar to FIG. 5A taken generally along the line 5B-5B of a thermal insulator constructed in accordance with another non-limiting of the disclosure.

### DETAILED DESCRIPTION OF PREFERRED EMBODIMENTS

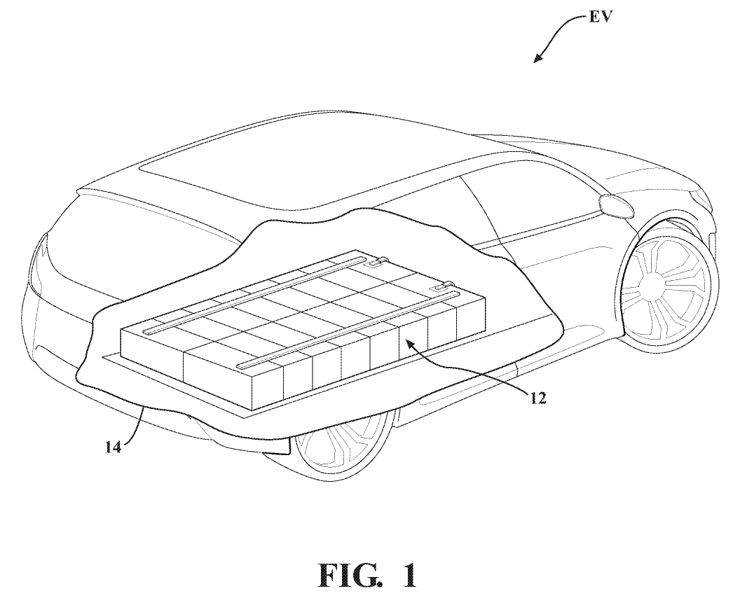

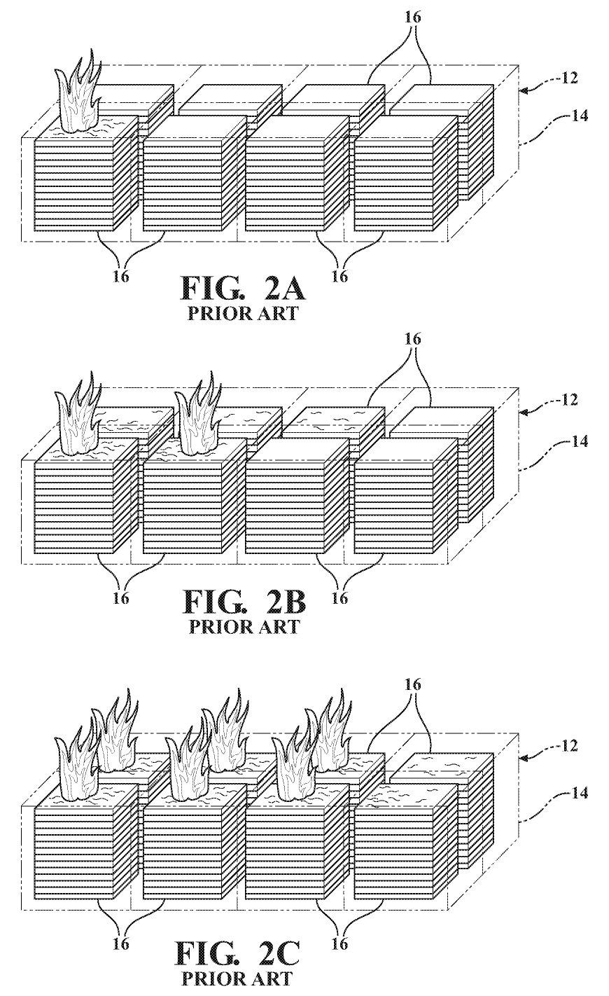

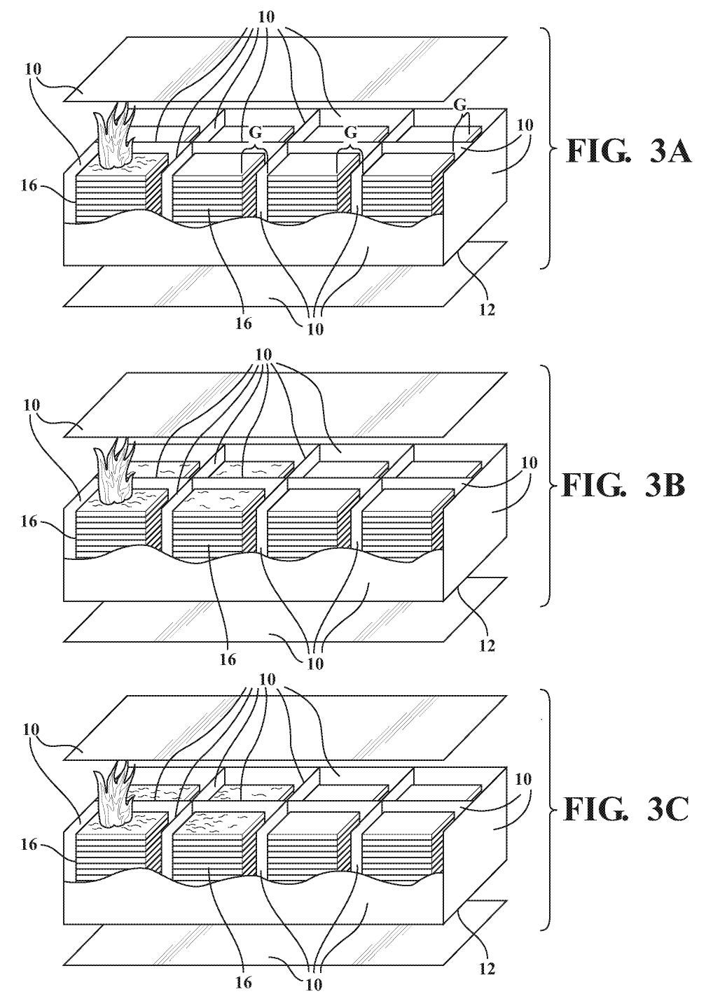

Referring in more detail to the drawings, FIG. 1 illustrates a motor vehicle, shown as an electrically powered motor vehicle, also referred to as electric vehicle EV, having a battery pack 12, such as a lithium-ion battery pack, by way of example and without limitation, configured with a thermal insulator 10 in accordance with an aspect of the invention. The electric vehicle battery pack 12 includes a housing member, also referred to as casing or housing 14, bounding a plurality of cells, wherein a cluster of the cells form a cell module 16 spaced from one another by gaps G (FIG. 3A) and including busbars electrically interconnecting cell modules 16 with one another, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having one or more thermal insulators 10 as disclosed herein, whereat flame propagation can result, as shown in FIGS. 2A-2C, a thermal runaway condition originating in any one of the cell modules 16 of battery pack 12, with the thermal insulator(s) 10 being disposed within the gaps G and/or about the cell modules 16, is controlled and contained via the thermal insulator(s) 10, as illustrated schematically in FIGS. 3A-3C, such that flame propagation is prevented for at least 5 minutes at an internal cell temperature ranging between 1000 – 1200 ^{o}C, and an outer surface temperature of a backplate of the battery housing 14, also referred to as case, is maintained to be less than 1000 ^{o}C for 5 minutes or more.

As shown schematically in FIGS. 3A-3C, at least one or a plurality of the thermal insulator(s) 10 are arranged to thermally isolate the cell modules 16 from one another by being disposed with gaps G between the cell modules 16. The thermal insulator(s) 10 shield and protect surfaces of the battery pack housing 14 and members of the battery pack 12, against extreme temperature thermal runaway conditions and contamination, such as from fluid or debris, as well as from impact forces, such as may be experienced in a crash condition. Each thermal insulator 10 is provided having a relatively thin, flexible wall 18, such as having a thickness (t) between about 18.0mm-30.0mm. The wall 18 provides a protective outer barrier about an outer periphery of the cell modules 16, as well as providing a protective barrier between adjacent cells 16 by being disposed within gaps G to effectively thermally isolate each cell module 16 from an adjacent cell module 16.

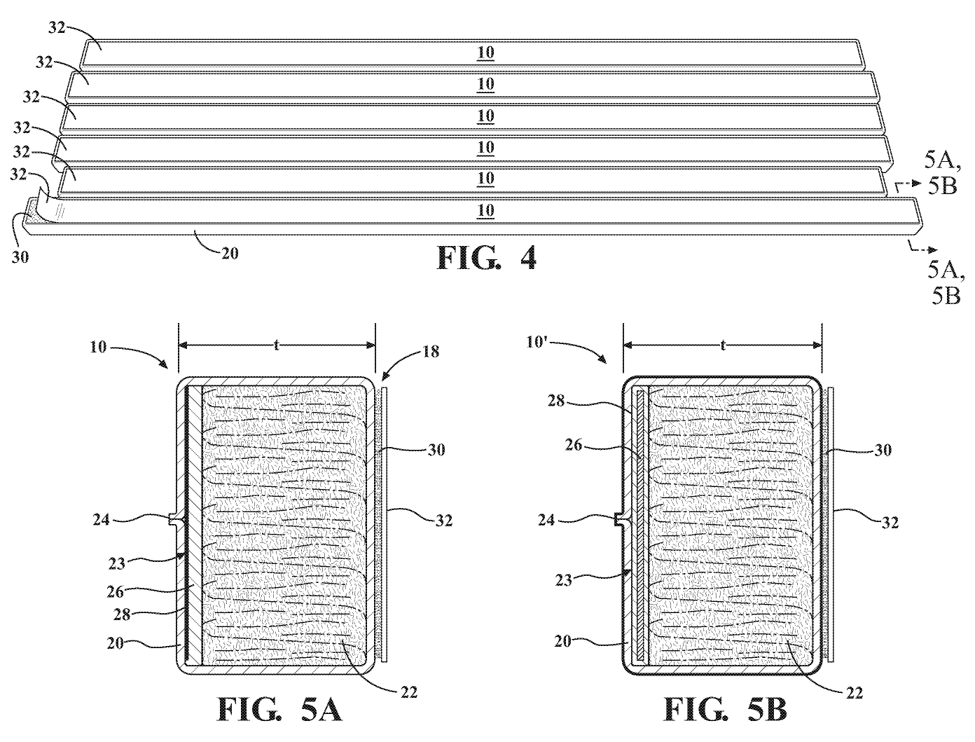

The wall 18, in one non-limiting embodiment illustrated, as best shown in FIG. 5A, is shown including a polymeric outer layer, and preferably a polymeric outer layer, and provided in a preferred embodiment as a heat-shrinkable polymeric outer layer 20, having a gauge between about 50-90, a mechanically bonded nonwoven mineral material, also referred to as nonwoven layer 22, having a thickness, while in a free state, that is greater than the thickness of the gap G, such as being greater in thickness than the gap G by between about 1-6mm, thereby necessitating a tight, compression fit of the wall 18 within the gap G, and a thermal barrier layer 23 abutting the nonwoven layer 22. The compression fit aids in restraining the thermal insulator 10 in its desired location between the cell modules 16, thereby negating the need for secondary fixation mechanisms. In one embodiment according to the disclosure, the thickness t is between about 16-30mm. Accordingly, the thickness t (FIG. 5A) of the thermal insulator 10 is provided substantially by the thickness t of the nonwoven layer 22, with the thickness of the thermal barrier layer 23 further contributing to the total thickness t of the thermal insulator 10. The thickness of the thermal barrier layer 23 can range between about 0.5-2.0mm, depending on the denier of heat-resistant mineral yarn used for the thermal barrier layer 23.

The nonwoven layer 22 and the thermal barrier layer 23 are fully encapsulated by the outer heat-shrunk polymeric layer 20. The outer heat-shrunk polymeric layer 20 can be provided as a generally rectangular sheet that is wrapped about the nonwoven layer 22 and the thermal barrier layer 23, and then subsequently heat-sealed along one or more heat-sealed seam(s) 24 to fully encapsulate the nonwoven layer 22 and thermal barrier layer 23. Then, the outer heat-shrunk polymeric layer 20 can be heated sufficiently to cause it to shrink into a close, relatively snug fit about the nonwoven layer 22 and thermal barrier layer 23. If desired, the shrinking process can be controlled to provide an air layer between the outer layer 20 and the internal nonwoven and thermal barrier layers 22, 23 to allow relative movement therebetween, as well as to enhance the thermal insulation properties of the wall 18, thus, further reducing flame propagation across the thermal insulator 10. The nonwoven material 22 can include various grades of fiberglass/e-glass, silica, nomex, basalt, ceramic, etc, by way of example and without limitation, and can be cut to any desired shape, including symmetrical or non-symmetrical shapes. Regardless of the material selected, the nonwoven material 22 has a gsm between about 2500-9000gsm, which can be selected based on the thickness of the gap G to provide the desired compression fit and thermal, heat-resistance properties, enhanced by the heat-shrunk outer layer 20. It is to be understood that the nonwoven layer 22 can be provided as a single, monolithic piece of material, or multiple layers of nonwoven material 22 can be stacked together and shrunk wrapped by the heat-shrunk outer layer 20, wherein the heat-shrunk outer layer 20 can facilitate holding the multiple nonwoven layers in tightly sandwiched relation with one another and with the thermal barrier layer 23 abutting the nonwoven layer(s) 22. Further, if desired, the multiple nonwoven layers 22 could be fixed together by intertwining fibers of the separate layers 22 with one another, such as in a needling process, wherein needles carry fibers from one layer 22 to an adjacent layer 22 to interconnect the separate layers 22 to one another. By interconnecting separate layers to one another, both manufacture of the desired total thickness of the nonwoven layer 22 can be made easier by not having to make the total thickness in a single nonwoven operation, and handling can be made easier in the encapsulation process with the individual layers 22 being fixed to one another. Further, the multiple nonwoven layers 22 could be fixed together via an adhesive layer, such as an acrylic adhesive or otherwise, wherein the adhesive layer could extend between the entirety of the nonwoven layers 22, or to minimize an amount a flame fuel, the adhesive can be selectively located at corners of the individual layers 22, by way of example and without limitation, thereby holding the layers 22 together until the outer layer 20 is wrapped and shrunken about the layers 22. It is further to be understood that the same suitable adhesive could be used to hold the nonwoven layer 22 to the thermal barrier layer 23 until the outer layer 20 is wrapped and shrunken about the nonwoven and thermal barrier layers 22, 23.

The thermal barrier layer 23 (FIG. 5A) can be provided including a textile fabric layer 26 interlaced with fibers or yarns resistant to high temperature. If the textile fabric layer 26 is formed of fibers, the fibers can be interlaced as a nonwoven layer, such as a spunbonded layer 26. Otherwise, if the fabric layer 26 is formed of yarn filaments, the yarns can be woven including lengthwise extending warp yarns and widthwise extending weft yarns. The fibers or yarns of the textile fabric layer 26 are provided entirely of fibers or yarns resistant to extreme heat, such as fibers or multifilament of mineral yarn. The fibers or yarns of the textile fabric layer 26 can include fiberglass, ceramic, basalt, or other materials known for high heat resistance.

To further enhance the resistance to heat and flame, the thermal insulator 10 is constructed with the thermal barrier layer 23 including a layer of mica coating or a layer of mica-based coating 28. The mica-based coating 28 can be formed solely on a side facing away from the textile fabric layer 26 (FIG. 5A) or formed in an alternate thermal insulator 10’ embodiment to encapsulate the textile fabric layer 26 (FIG. 5B). The mica-based coating 28 is provided as a compound including between about 5 – 30% by mass powdered mica. The powdered mica is infused in a base material of the compound, such as liquid silicone rubber (LSR), by way of example and without limitation. The mica-based coating 28 can then be applied and bonded to the textile fabric layer 26 of the thermal barrier layer 23, such that the mica-based coating forms a side of the thermal barrier layer 23 facing away from the nonwoven layer 22. As such, the mica or a mica-based coating 28 is on an opposite side of the thermal barrier layer 23 from the nonwoven layer 22. Accordingly, the textile fabric layer 26 is sandwiched between the mica or mica-based coating 28 and the nonwoven layer 22, and more particularly, the textile fabric layer 26 is sandwiched directly between the thermal barrier layer 23 and the nonwoven layer 22. It is to be recognized that the mica or mica-based coating can be applied to the textile fabric layer 26 via any desired application process, such as spraying, dipping, rolling, or otherwise.

The heat-shrunk outer layer 20 can be provided as a film of a variety of heat-shrinkable polymeric materials, including polyolefin, PEEK, PVC, polypropylene, polyester, etc, by way of example and without limitation. The heat-shrunk outer layer 20 can be disposed and shrunk about the nonwoven layer 22 and the thermal barrier layer 23 to provide the aforementioned air layer, or the heat-shrunk outer layer 20 can be shrunken into tight compression with the nonwoven layer 22 and the thermal barrier layer 23. Regardless, the heat-shrunk outer layer 20 facilitates assembly within the gap G by providing a reduced friction surface relative to the friction of the nonwoven layer 22 and the thermal barrier layer 23, thereby improving assembly efficiency in addition to preventing unwanted buckling or bunching of the nonwoven layer 22, in addition to enhancing the thermal properties of the thermal insulator 10. The heat-shrunk outer layer 20 can be provided as a single, monolithic piece of material that is folded about the nonwoven layer 22 and then adhered to itself via a heat-cutting operation, thereby forming the heat-sealed seam 24 along the length and along the opposite ends of the thermal insulator 10, by way of example and without limitation. It is contemplated that the outer layer 20 can include other arrangements of seams and further could be provided a pair of sheets laid over opposite sides of the nonwoven layer 22 and the thermal barrier layer 23, followed by a heat-sealing operation to form heat-sealed seam(s) 24 about the entire periphery of the nonwoven layer 22, followed by a heat-shrinking operation. Regardless, the outer layer 20 fully encapsulates the nonwoven layer 22 and the thermal barrier layer 23 and is heat-shrunk into a snug or substantially snug fit about the nonwoven layer 22.

To facilitate fixing and maintaining the wall 18 in the desired position with the gap G, a pressure-sensitive adhesive layer 30 can be applied to an outer surface of the heat-shrunk polymeric outer layer 20. The pressure-sensitive layer 30 is shown applied to one side of the thermal insulator 10, 10’, opposite the thermal barrier layer 23, with the pressure-sensitive layer 30 shown facing outwardly from the nonwoven layer 22, such that the pressure-sensitive adhesive layer 30 can be exposed for adhesion to an inner surface of the casing 14, thereby orienting the thermal insulation layer, labeled as flame barrier 23, 26, to directly face the cells 16. The pressure sensitive adhesive layer 30 can be provided as the only adhesive layer of the insulator 10, thereby minimizing the amount of fuel for flame. The pressure-sensitive adhesive layer 30 can be provided as an acrylic material, thereby being heat-resistant. Prior to use and application, the pressure-sensitive adhesive layer 30 can be covered and protected by a release film, also referred to as release layer 32, wherein the release layer 32 is selectively removed from the pressure sensitive adhesive layer 30 for use, when desired.

Obviously, many modifications and variations of the present invention are possible in light of the above teachings. It is contemplated that all features of all claims and of all embodiments can be combined with each other, so long as such combinations would not contradict one another.

It is, therefore, to be understood that within the scope of the appended claims, the invention may be practiced otherwise than as specifically described.

What is claimed is:

1. A thermal insulator for a battery pack, comprising:
a nonwoven layer;
a thermal barrier layer abutting the nonwoven layer; and
a polymeric outer layer,
wherein the nonwoven layer and the thermal barrier layer are encapsulated by the polymeric outer layer.

2. The thermal insulator of claim 1, wherein the thermal barrier layer includes a textile fabric layer interlaced with material resistant to high temperature.

3. The thermal insulator of claim 2, wherein the material of the textile fabric layer includes woven yarns.

4. The thermal insulator of claim 3, wherein the yarns of the textile fabric layer include mineral yarn.

5. The thermal insulator of claim 2, wherein the thermal barrier layer includes a mica-based coating.

6. The thermal insulator of claim 5, wherein the thermal barrier layer includes a polymeric film, wherein the mica-based coating is sandwiched between the textile fabric layer and the polymeric film.

7. The thermal insulator of claim 6, wherein the polymeric film is one of a PEEK material and a polyester material.

8. The thermal insulator of claim 1, wherein the nonwoven layer has a gsm between about 2500-9000gsm.

9. The thermal insulator of claim 8, wherein the nonwoven layer is a mineral material.

10. The thermal insulator of claim 8, wherein the nonwoven wall has a thickness between about 24-30mm.

11. The thermal insulator of claim 1, wherein the outer polymeric layer is heat-shrunk and has a gauge between about 50-90.

12. The thermal insulator of claim 11, wherein the outer heat-shrunk polymeric layer is one of a PEEK material and a polyolefin material.

13. A thermal insulator for a battery module, consisting of:
a nonwoven layer;
a thermal barrier layer abutting the nonwoven layer; and
an outer heat-shrunk polymeric layer,
wherein the nonwoven layer and the thermal barrier layer are encapsulated by the outer heat-shrunk polymeric layer.

14. The thermal insulator of claim 13, wherein the thermal barrier layer includes a textile fabric layer interlaced with yarns resistant to high temperature.

15. The thermal insulator of claim 14, wherein the yarns of the textile fabric layer are woven.

16. The thermal insulator of claim 14, wherein the yarns of the textile fabric layer include mineral yarn.

17. The thermal insulator of claim 13, wherein the thermal barrier layer includes a mica-based coating.

18. The thermal insulator of claim 17, wherein the thermal barrier layer includes a polymeric film, wherein the mica-based coating is bonded to the polymeric film.

19. An electric vehicle battery pack, comprising:
a housing;
a plurality of cell modules bounded by said housing, said cell modules spaced from one another by a gap; and
a thermal insulator including a nonwoven layer, a thermal barrier layer abutting the nonwoven layer, and an outer heat-shrunk polymeric layer encapsulating the nonwoven layer and the thermal barrier layer,
wherein the thermal insulator is compressed within the gap.

20. The electric vehicle battery pack of claim 19, wherein the thermal insulator, while in a free state, has a thickness greater than a width of the gap.
